(19) United States
(12) Patent Application Publication
(10) Pub. No.: US 2020/0250840 A1
(43) Pub. Date: Aug. 6, 2020

(54) SHADOW DETECTION METHOD AND SYSTEM FOR SURVEILLANCE VIDEO IMAGE, AND SHADOW REMOVING METHOD

(71) Applicant: SUZHOU KEDA TECHNOLOGY CO., LTD., New District Suzhou (CN)

(72) Inventors: Zhaolong JIN, Suzhou (CN); Wenyi ZOU, Suzhou (CN); Weidong CHEN, Suzhou (CN)

(21) Appl. No.: 16/852,597

(22) Filed: Apr. 20, 2020

Related U.S. Application Data
(63) Continuation of application No. PCT/CN2018/110701, filed on Oct. 17, 2018.

(30) Foreign Application Priority Data
Oct. 20, 2017 (CN) 201710986529.9

(51) Int. Cl. G06T 7/269; G06T 7/49; G06T 7/90; G06T 7/62; G06T 7/194; G06T 7/73

(52) U.S. Cl. CPC G06T 7/269; G06T 7/49; G06T 7/90; G06T 2207/30232; G06T 7/194; G06T 7/73; G06T 2207/10016; G06T 7/62

(57) ABSTRACT

The present application discloses a shadow detection method and system for monitoring video images, and a shadow removal method. The shadow detection method includes: acquiring a current frame and a background frame from source data; acquiring, from the current frame, first candidate shadow areas; computing a local-ternary-pattern shadow detection value of the first candidate shadow areas, and selecting second candidate shadow areas; computing a hue detection value, a saturation detection value and a gradient detection value of the second candidate shadow areas; estimating a local-ternary-pattern shadow threshold, a hue threshold, a saturation threshold and a gradient threshold; computing a local-ternary-pattern shadow detection value, a hue detection value, a saturation detection value and a gradient detection value of the first candidate shadow areas; and selecting first candidate shadow areas.

### CROSS REFERENCE TO RELATED APPLICATIONS

This application is a continuation of International Application No. PCT/CN2018/110701, filed on Oct. 17, 2018, which is based upon and claims priority to Chinese Patent Application No. 201710986529.9, filed on Oct. 20, 2017, the entire contents of which are incorporated herein by reference.

### TECHNICAL FIELD

The present application relates to the field of image processing technology, in particular, to a shadow detection method for monitoring video images, a shadow detection system for monitoring video images, and a shadow removal method for monitoring video images using the shadow detection method for monitoring video images.

### BACKGROUND

Monitoring system is one of the most widely used systems in security systems. For monitoring technology, shadows in a monitored scene (comprising the shadow of a monitored target and the shadow of other background objects, etc.) have always been important factors that interfere with monitoring and detection of monitored targets. Especially under lighting conditions, the shadow projected by a monitored target in motion always accompanies the monitored target itself, that is, the shadow projected by the monitored target has similar motion properties as the monitored target, and both the projected shadow and the monitored target are distinct from the corresponding background area to a great extent, thus the projected shadow can be easily detected together with the monitored target in motion.

If the shadow is mistakenly detected simultaneously as a monitored target, it is easy to cause adhesion, fusion, and geometric attribute distortion of the monitored target. Therefore, how to detect a moving target in a monitoring video scene to eliminate the interference of the projected shadow and ensuring the integrity of the monitored target as much as possible are of great significance to intelligent video analysis.

### SUMMARY

In view of the deficiency in the prior art, the objective of the present application is to provide a shadow detection method for monitoring video images, a shadow detection system for monitoring video images, and a shadow removal method for monitoring video images using the shadow detection method for monitoring video images. The shadow detection method for monitoring video images, the shadow detection system, and the shadow removal method for monitoring video images can effectively detect and remove shadows, and minimize the impact of shadows on the integrity of a monitored target.

In one aspect according to the present application, a shadow detection method for monitoring video images is provided which comprises the following steps: S10, acquiring a current frame and a background frame from source data; S20, acquiring, from the current frame, first candidate shadow areas with brightness smaller than that of corresponding areas of the background frame; S30, computing a local-ternary-pattern shadow detection value of all of the first candidate shadow areas, and selecting first candidate shadow areas with the local-ternary-pattern shadow detection value greater than the first threshold as second candidate shadow areas; S40, computing a hue detection value and a saturation detection value and a gradient detection value of each of the second candidate shadow areas; S50, estimating a corresponding local-ternary-pattern shadow threshold, a corresponding hue threshold, a corresponding saturation threshold and a corresponding gradient threshold according to the local-ternary-pattern shadow detection value, the hue detection value, the saturation detection value and the gradient detection value of the second candidate shadow areas computed; S60, computing a local-ternary-pattern shadow detection value, a hue detection value, a saturation detection value and a gradient detection value of each of the first candidate shadow areas; and S70, selecting first candidate shadow areas whose local-ternary-pattern shadow detection value, hue detection value, saturation detection value and gradient detection value all fall in a range of the local-ternary-pattern shadow threshold, the hue threshold, the saturation threshold and the gradient threshold as shadow areas.

In another aspect according to the present application, a shadow removal method for monitoring video images is further provided, which at least comprises the following steps for the realizing the shadow detection method for monitoring video images: S10, acquiring a current frame and a background frame from source data; S20, acquiring, from the current frame, first candidate shadow areas with brightness smaller than that of corresponding areas of the background frame; S30, computing local-ternary-pattern shadow detection values of all of the first candidate shadow areas, and selecting first candidate shadow areas with the local-ternary-pattern shadow detection values greater than the first threshold as second candidate shadow areas; S40, computing a hue detection value, a saturation detection value and a gradient detection value of each of the second candidate shadow areas; S50, estimating a corresponding local-ternary-pattern shadow threshold, a corresponding hue threshold, a corresponding saturation threshold and a corresponding gradient threshold according to the local-ternary-pattern shadow detection value, the hue detection value, the saturation detection value and the gradient detection value of the second candidate shadow areas computed; S60, computing a local-ternary-pattern shadow detection value, a hue value, a saturation detection value and a gradient detection value of each of the first candidate shadow areas; and S70, selecting first candidate shadow areas whose local-ternary-pattern shadow detection value, hue detection value, saturation detection value and gradient detection value all fall in a range of the local-ternary-pattern shadow threshold, the hue threshold, the saturation threshold and the gradient threshold as shadow areas.

According to another aspect of the present application, a shadow detection system for monitoring video images is further provided, which comprises: an extraction module, for acquiring a current frame, a background frame or a foreground frame from source data; a first candidate shadow area acquisition module, for acquiring, from the current frame, first candidate shadow areas with brightness smaller than that of corresponding areas of the background frame; a second candidate shadow area acquisition module, for computing local-ternary-pattern shadow detection values of all the first candidate shadow areas, and selecting first candidate shadow area with the local-ternary-pattern shadow detection values greater than the first threshold as second candidate shadow areas; a first computation module, for computing a hue detection value, a saturation detection value and a gradient detection value of each of the second candidate shadow areas; a threshold estimation module, for estimating a corresponding local-ternary-pattern shadow threshold, a corresponding hue threshold, a corresponding saturation threshold and a corresponding gradient threshold according to the local-ternary-pattern shadow detection value, the hue detection value, saturation detection value and gradient detection value of the second candidate shadow areas computed; a second computation module, for computing a local-ternary-pattern shadow detection value, a hue value, a saturation detection value and a gradient detection value of each of the first candidate shadow areas; and a shadow area selection module, for selecting first candidate shadow areas whose local-ternary-pattern shadow detection value, hue detection value, saturation detection value and gradient detection value all fall in a range of the local-ternary-pattern shadow threshold, the hue threshold, the saturation threshold and the gradient threshold as shadow areas.

Compared with the prior art, in the shadow detection method for monitoring video images, the shadow detection system for monitoring video images and the shadow removal method for monitoring video images using the same shadow detection method provided by embodiments of the present application, first candidate shadow areas (rough candidate shadow areas) are firstly acquired, and a small part of the true second candidate shadow area is extracted from the first candidate shadow area for estimating threshold parameters of subsequent three shadow detectors. Based on the principle of texture consistency and chrominance constancy in the shadow area and the corresponding background area, the three shadow detectors are used to extract relatively accurate shadow areas from the first candidate shadow area in parallel, and then the all more accurate shadow areas are jointly screened to obtain a more accurate shadow area. Therefore, the shadow detection method for monitoring video images of the present application has significant detection effect when the shadow area of an acquired monitored target in motion is detected for most common indoor scenes, and can detect very accurate shadow areas. In addition, the algorithm embodied by the above processes can be applied as an independent module in monitoring scenes, combined with a background modelling or background difference algorithm, and based on the real-time video frame (the current frame), the foreground frame, and the background frame, the algorithm can be implemented and applied to reduce the impact of shadows on the integrity of the target to the maximum extent, so that the monitored target obtained after the shadow area is removed is also more accurate and complete, which is more conducive to the monitoring of the monitored target.

### BRIEF DESCRIPTION OF THE DRAWINGS

By reading the detailed description of the non-limiting embodiment with reference to the following drawings, other features, purposes and advantages of the present application will become more apparent:

FIG. 1 is a flow chart of a shadow detection method for an image in an embodiment of the present application;

FIG. 2 is a flow chart for each step for acquiring first candidate shadow areas of a shadow detection method for an image in an embodiment of the present application;

FIG. 3 is a computation flow chart for an improved local-ternary-pattern shadow detection value of a shadow detection method for an image in an embodiment of the present application;

FIG. 4 is a computation flow chart for an improved local-ternary-pattern computation value of a shadow detection method for an image in an embodiment of the present application; and

FIG. 5 is a computation result schematic view for an improved local-ternary-pattern computation value of a shadow detection method for an image in an embodiment of the present application.

### DETAILED DESCRIPTION

Exemplary implementations will now be described more fully in conjunction with the accompanying drawings. However, the exemplary implementations can be implemented in a variety of forms and should not be construed as limited to the implementations set forth herein; instead, providing these implementations makes the present application comprehensive and complete, And fully convey the concept of the exemplary implementations to those skilled in the art. In the figures, the same reference numerals indicate the same or similar structures, so repeated description thereof will be omitted.

According to the main concept of the present application, the shadow detection method for monitoring video images of the present application comprises the following steps: acquiring a current frame and a background frame from source data; acquiring, from the current frame, first candidate shadow areas with brightness smaller than that of a corresponding areas of the background frame; computing local-ternary-pattern shadow detection values of all of the first candidate shadow areas, and selecting first candidate shadow areas with the local-ternary-pattern shadow detection values greater than the first threshold as second candidate shadow areas; computing a hue detection value, a saturation detection value and a gradient detection value of each of the second candidate shadow areas; estimating a corresponding local-ternary-pattern shadow threshold, a corresponding hue threshold, a corresponding saturation threshold and a corresponding gradient threshold according to the local-ternary-pattern shadow detection value, hue detection value, saturation detection value and gradient detection value of the second candidate shadow areas computed; computing a local-ternary-pattern shadow detection value of all of the first candidate shadow areas, and selecting first candidate shadow areas whose local-ternary-pattern shadow detection value greater than the first threshold as second candidate shadow areas; computing a hue detection value, a saturation detection value and a gradient detection value of each of the second candidate shadow areas; selecting first candidate shadow areas whose local-ternary-pattern shadow detection value, hue detection value, saturation detection value and gradient detection value all fall in a range of the local-ternary-pattern shadow threshold, the hue threshold, the saturation threshold and the gradient threshold as shadow areas.

The technical content of the present application will be described in the following in combination with the accompanying drawings and the embodiments.

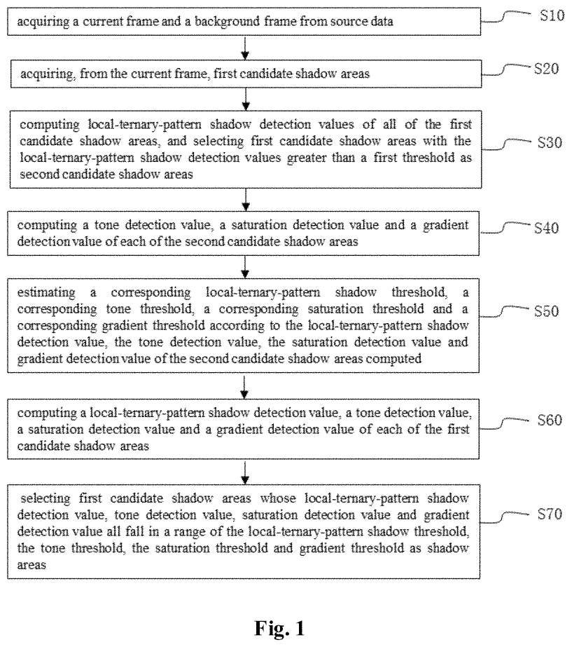

Please refer to FIG. 1, which shows a flow chart of a shadow detection method for an image in an embodiment of the present application. Specifically, the shadow detection method for monitoring video images of the present application is mainly applied to two color spaces: hue, saturation, value (HSV) color space and a red-green-blue (RGB) color space; two textures: a gradient and a local space mode. The main idea in the algorithm of the shadow detection method for monitoring video images is to first extract candidate shadow areas (referring to the first candidate shadow area and the second candidate shadow area below), and then extract the shadow areas from the candidate shadow areas. The extracted shadow area is more accurate. Specifically, as shown in FIG. 1, in the embodiment of the present application, the shadow detection method for monitoring video images comprises the following steps:

Step S10: acquiring a current frame and a background frame from source data. Wherein, the source data refers to an original image or video data acquired by a monitoring device; the current frame refers to the current image collected in real time, and the background frame is a background image without monitored targets and extracted from a monitoring screen or video by means of background modeling or background difference algorithm, etc. Further, in a preferred embodiment of the present application, step S10 further includes the step of acquiring a foreground frame from the source data simultaneously, wherein, the foreground frame refers to monitored images recorded at a time earlier than that of the current frame during the operation of the monitoring device.

Step S20: acquiring, from the current frame, first candidate shadow areas with brightness smaller than that of a corresponding areas of the background frame. Specifically, this step is mainly based on the assumption that the shadow areas are darker than corresponding background areas. This assumption is true in most cases. Therefore, rough candidate shadow areas (that are, the above first candidate shadow areas) can be extracted under this assumption. Therefore, the brightness of the acquired first candidate shadow areas are smaller than that of corresponding areas in the background frame. It should be noted that the background frame is an image without monitored targets, that is, the image of the areas in the current frame except for the monitored targets and the shadow areas is the same as that in the background frame, so the first candidate shadow areas in the current frame are at essentially the same position as the corresponding areas in the background.

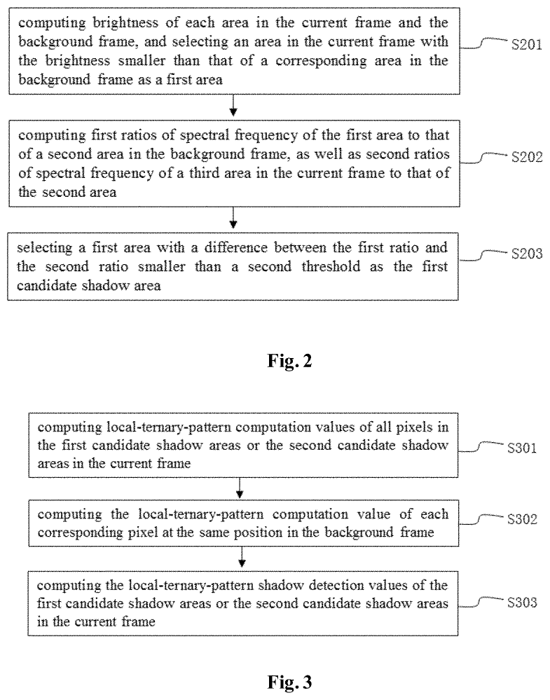

Further, because the shadow area may be affected by noise, Therefore, the first candidate shadow areas actually acquired in step S20 include most of the real shadow areas and the monitored targets that are falsely detected as the shadow area. If the assumption of chroma darkness is used to judge it, the area of falsely detected as the shadow region will be large. Furthermore, in the embodiment of the present application, when performing statistical analysis on the monitored target and the shadow area, the inventor finds that the ratio of the spectral frequency of each color channel of the shadow area in the red, green, and blue (RGB) color space undergoes a smaller change than the ratio of the spectral frequency of each color channel of a corresponding background area; whereas the ratio of the spectral frequency of each color channel of the monitored target undergoes a greater change than the ratio of the spectral frequency of each color channel of a corresponding background area. This feature helps distinguish most of the monitored targets that are falsely detected as shadow areas from the detected candidate shadow areas. Therefore, referring to FIG. 2, which shows a flow chart for each step for acquiring a first candidate shadow area of a shadow detection method for an image in an embodiment of the present application. Specifically, in the preferred embodiment of the present application, step S20 further includes the following steps:

Step S201: computing brightness of each area in the current frame and the background frame, and selecting an area in the current frame with the brightness smaller than that of a corresponding area in the background frame as a first area.

Step S202: computing three first ratios of spectral frequency respectively in red, green and blue channels of the first area to that of a second area corresponding to the first area in the background frame, as well as three second ratios of spectral frequency respectively in red, green and blue channels of a third area corresponding to the first area in the foreground frame to that of the second area, wherein, the first area, the second area and the third area are essentially the same area in the image.

Specifically, in step S202, the computation methods of the three first ratio are:

$${Ψ}_{r} = \frac{{C}_{b} \text{/} {C}_{g}}{{B}_{b} \text{/} {B}_{g}} , {Ψ}_{g} = \frac{{C}_{b} \text{/} {C}_{r}}{{B}_{b} \text{/} {B}_{r}} , {Ψ}_{b} = \frac{{C}_{g} \text{/} {C}_{r}}{{B}_{g} \text{/} {B}_{r}}$$

wherein, Ψᵣ is a first ratio of the spectral frequency in a red channel, Ψ_{g} is a first ratio of the spectral frequency in a green channel, and b is a first ratio of the spectral frequency in the blue channel; Cᵣ is a spectral frequency of the red channel in the current frame, C_{g} is a spectral frequency of the green channel in the current frame, and C_{b} is a spectral frequency of the blue channel in the current frame; Bᵣ is a spectral frequency of the background frame in the red channel, B_{g} is a spectral frequency of the background frame in the green channel, and Bb is a spectral frequency of the background frame in the blue channel.

Correspondingly, in the foreground frame, three second ratios of the spectral frequency in the red, green and blue channels of the third area corresponding to the first area to that of and second area are respectively computed in the same way as the first ratio, wherein only parameters corresponding to the current frame are substituted while related parameters of the background frame are retained. For example, Cg is replaced with the spectral frequency of the foreground frame in the red channel. Other parameters of the current frame are similarly replaced, and will not be repeated here.

Step S203: selecting a first area with a difference between the first ratio and the second ratio smaller than the second threshold as the first candidate shadow area, wherein, the second threshold may be set and adjusted according to actual demands.

Step S30: computing a local-ternary-pattern shadow detection value of all of the first candidate shadow areas, and selecting first candidate shadow areas with the local-ternary-pattern shadow detection value greater than a first threshold as second candidate shadow areas. Specifically, the present application mainly uses three shadow detectors to detect the shadow areas. Each shadow detector has a corresponding parameter threshold, but because the scene in a monitoring video is changeable, it will limit the application of the algorithm if a group of parameter thresholds are needed to be set for each scene, so it is necessary to predict more accurate parameter thresholds in advance. Furthermore, on the basis of the acquisition of the first candidate shadow area in the above step S20, the present application uses an improved local-ternary-pattern) detector (hereinafter referred to as the ILTP detector) to screen all of the selected first candidate shadow areas, and select accurate shadow areas (that is, these shadow areas have a high detection standard, and the selected areas are basically the final shadow areas), and estimate threshold parameters of the three shadow detectors (a hue detector, a saturation detector and a gradient detector) for the detection of other first candidate shadow areas based on these accurate shadow areas. It should be noted that in this step, the ILTP detector is chosen due to higher accuracy and less target interference thereof than the hue and saturation (HS) detector and the gradient (Gradient) detector in the detection of the shadow areas.

Further, referring to FIG. 3, which illustrates a computation flow chart for an improved local-ternary-pattern shadow detection value of a shadow detection method for an image in an embodiment of the present application. Specifically, the computation of the improved local-ternary-pattern shadow detection value in the present application includes the following steps:

Step S301: computing a local-ternary-pattern computation value of all pixels in the first candidate shadow area or the second candidate shadow area in the current frame. Specifically, the local-ternary-pattern computation value (ILTP computed value) is computed for the pixels in the first candidate shadow area in the above step S30 in the present application.

Step S302: computing the local-ternary-pattern computation value of each corresponding pixel at the same position in the background frame.

Step S303: computing the number of pixels in the first candidate shadow areas or the second candidate shadow areas in the current frame that have the same local-ternary-pattern computation value as corresponding pixels in the background frame, and using the number of pixels as the local-ternary-pattern shadow detection value. Specifically, in this step, comparing the computed ILTP computed values of each pixel in the above step S301 and step S302, if the ILTP computed value of a certain pixel of the current frame in step S301 is the same as the ILTP computed value of a corresponding (that is, at the same position) pixel in step S302, then the pixel can be counted as 1 pixel. Furthermore, similarly computing all pixels in the first candidate area, accumulating the pixels that meet the above conditions, so as to acquire the local-ternary-pattern shadow detection value.

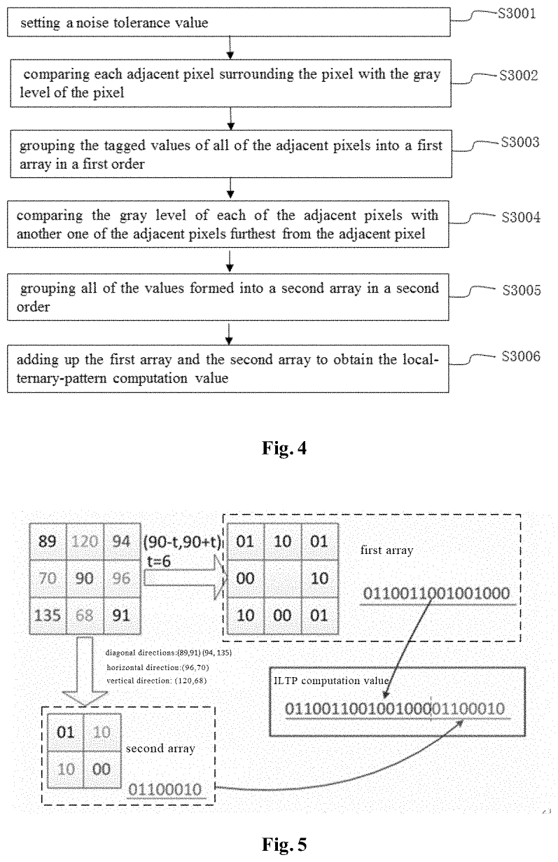

Further, referring to FIG. 4, which shows a computation flow chart for an improved local-ternary-pattern shadow detection value of a shadow detection method for an image in an embodiment of the present application. As shown in FIG. 4, in the above step S301 and S302, the computation method of the local-ternary-pattern computation value at least includes the following steps:

Step S3001: setting a noise tolerance value.

Step S3002: comparing each adjacent pixel surrounding the pixel with the gray level of the pixel, so as to obtain the following three results, that is, only three computation values. Specifically, if difference in the gray level between an adjacent pixel and the pixel is smaller than the noise tolerance value, then the value of the adjacent pixel is tagged as a first value; if the gray level of an adjacent pixel is greater than or equal to the sum of the gray level of the pixel and the noise tolerance value, the value of the adjacent pixel is tagged as a second value; if the gray level of an adjacent pixel is smaller than or equal to the difference between the gray level and the noise tolerance value, then the value of the adjacent pixel is tagged as a third value.

Referring to FIG. 5, which shows a computation result schematic view for an improved local-ternary-pattern shadow detection value of a shadow detection method for an image in an embodiment of the present application. In the embodiment shown in FIG. 5, the detected pixel and a plurality of the adjacent pixels are arranged in a nine-palace lattice, and each of the pixel is surrounded by eight of the adjacent pixels arranged around it. The gray level of the detected pixel in FIG. 5 is 90, the noise tolerance value t is 6, the first value is 01, the second value is 10, and the third value is 00. Furthermore, according to the comparison method in the above step S3002, the adjacent pixel located at the upper left corner of the detected pixel is tagged as 01, the adjacent pixel located on the left side of the detected pixel is tagged as 00, the adjacent pixel located above the detected pixel is tagged as 10, and the surrounding eight adjacent pixels are similarly tagged (referring to the Sudoku tagged in FIG. 5), for performing step S3003.

Step S3003: grouping the tagged values of all of the adjacent pixels into a first array in a first order. In the embodiment shown in FIG. 5, the first order starts from an adjacent pixel in the upper left corner of the Sudoku formed by eight adjacent pixels, which are arranged clockwise sequentially to form the first array. Since all adjacent pixels are tagged by the first value 01, the second value 10 and the third value 00, the first array is essentially a string of numbers consisting of 01, 10 and 00. As shown in FIG. 5, the first array formed after the completion of step S3003 is 0110011001001000.

Step S3004: comparing the gray level of each of the adjacent pixels with another one of the adjacent pixels furthest from the adjacent pixel. If difference in the gray level between the two adjacent pixels is smaller than the noise tolerance value, then the value formed is the first value; if the gray level of the adjacent pixel of one of the adjacent pixels is greater than or equal to a sum of the gray level of another one of the adjacent pixel furthest from the adjacent pixel and the noise tolerance value, then the value formed is the second value; if the gray level of one of the adjacent pixels is smaller than or equal to the difference between the gray level of another one of the adjacent pixels furthest from the adjacent pixel and the noise tolerance value, then the value formed is the third value. Specifically, in the prior art, the local-ternary-pattern computation value is computed by only comparing the detected pixel with the surrounding adjacent pixels, ignoring the correlation information between the adjacent pixels, which can enhance the expression ability of the local-ternary-pattern computation value. Therefore, in the present application, the correlation information between the adjacent pixels is also included to improve the expression ability of the existing local-ternary-pattern computation value, and further, to make the detected shadow area more accurate. Furthermore, the comparison method in this step is the same as that in the above step S3003, with the difference that the pixels to be compared are different, and in step S3004, the comparison is performed between multiple adjacent pixels. In the embodiment as shown in FIG. 5, the comparison is performed between adjacent pixels along two diagonal directions, the vertical direction and the horizontal direction of the pixel to be detected. As shown in FIG. 5, the comparison is tagged in a [symbol] -shaped table. First of all, the value tagged in the space in the upper left corner of the [symbol] -shaped table is the comparison result between the adjacent pixel in the upper left corner and the adjacent pixel in the lower right corner of the [symbol] -shaped table, that is, comparison between gray level 89 and gray level 91, and because the difference between 89 and 91 is smaller than the noise tolerance value 6, the value in the upper left corner of the [symbol] -shaped table is tagged as the first value 01; similarly, the value in the upper-right corner of the [symbol] -shaped table is the comparison result between the adjacent pixel in the upper right corner and the adjacent pixel in the lower left corner of the Sudoku; the value in the lower left corner of the [symbol] -shaped table is the comparison result between the two adjacent pixels in the horizontal direction (that is, on the left side and right side of the detected pixel) in the Sudoku; the value in the upper right corner of the [symbol] -shaped table is the comparison result between two adjacent pixels in the value direction (that is, located above and below the detected pixel) in the Sudoku.

Step S3005: grouping all of the values formed into a second array in a second order. Specifically, in the embodiment shown in FIG. 5, the second order likewise starts from the upper left corner of the [symbol] -shaped table, which are arranged clockwise sequentially. Furthermore, in this embodiment, similar to the above first array, the second array includes four values, which can be referred to FIG. 5, and the second array is 01100010.

Step S3006: adding up the first array and the second array to obtain the local-ternary-pattern computation value. In the embodiment shown in FIG. 5, i.e., after the second array is directly added to the first array, the string of numbers is taken as a local-ternary-pattern computation value (the local-ternary-pattern computation value shown in FIG. 5 is 011001100100100001100010). The local-ternary-pattern computation value in FIG. 5 is composed of 12 values. If the three color channels are taken into account comprehensively in the RGB color space, the final ILTP computed value comprises 36 values.

Furthermore, the local-ternary-pattern computation value of the detected pixel in the current frame and a corresponding pixel in the background frame are respectively computed, to determine whether the local-ternary-pattern computation value of the above two pixels are the same, and compute the number of pixels which are the same (step S303). This number is the local-ternary-pattern shadow detection value of a first candidate shadow area finally acquired in step S30. The first candidate shadow area with a local-ternary-pattern shadow detection value greater than the first threshold will be used as the second candidate shadow area.

It should be noted that FIG. 5 merely shows an example, to which the application is not limited. In the actual detection process, parameters such as the above first order, the second order, the first value, the second value, and the third value can be set according to actual demands. In addition, the detected pixel and adjacent pixels thereof may even not form a Sudoku. For example, in some embodiments, the adjacent pixels may also surround the detected pixel in a ring shape, which will not be repeated here.

Step S40: computing a hue detection value, a saturation detection value and a gradient detection value of each of the second candidate shadow areas. Specifically, the hue detection value of the second candidate shadow area is an average value of the differences in the hue values between all pixels in the second candidate shadow area and all corresponding pixels in the background frame; similarly, the saturation detection value of the second candidate shadow area is an average value of the differences in the saturation values of all pixels in the second candidate shadow area and all corresponding pixels in the background frame.

Step S50: estimating a corresponding local-ternary-pattern shadow threshold, a corresponding hue threshold, a corresponding saturation threshold and a corresponding gradient threshold according to the local-ternary-pattern shadow detection value, the hue detection value, the saturation detection value and the gradient detection value of the second candidate shadow areas computed. Specifically, according to the above step S30, the computation method of the present application included the correlation information between the adjacent pixels and enhanced the local-ternary-pattern expression ability. Therefore, the acquired second candidate shadow areas are very accurate, and are basically the final shadow areas. Furthermore, the local-ternary-pattern shadow threshold, the hue threshold, the saturation threshold and the gradient threshold for detecting all first candidate shadow areas can be estimated according to the computed local-ternary-pattern shadow detection value, hue detection value, saturation detection value and gradient detection value of the second candidate shadow area. The estimation can be performed by taking an average value of the local-ternary-pattern shadow detection value of all second candidate shadow areas as the local-ternary-pattern shadow threshold; taking an average value of the hue and the saturation detection value of all second candidate shadow areas as the hue threshold and the saturation threshold; and taking the gradient detection value of all second candidate shadow areas as the gradient threshold. Or the above average value can also be adjusted as the final threshold according to actual demands, which will not be described in detail here.

Since the second candidate shadow area is detected by using the improved local-ternary-pattern shadow detection value of the present application, the selected second candidate shadow area is accurate and has low target interference. The threshold parameter of each shadow detector for determining subsequent all first candidate shadow areas will have better representativeness and accuracy.

Step S60: computing a local-ternary-pattern shadow detection value, a hue value, a saturation detection value and a gradient detection value of each of the first candidate shadow areas. In this step, the local-ternary-pattern shadow detection value, hue value, saturation detection value and gradient detection value are computed in the same method as the above step S30 and step S50.

Step S70: selecting first candidate shadow areas whose local-ternary-pattern shadow detection value, hue detection value, saturation detection value and gradient detection value all fall in a range of the local-ternary-pattern shadow threshold, the hue threshold, the saturation threshold and the gradient threshold as shadow areas. Specifically, in this step, the method in the above step S30 can be used to determine whether the local-ternary-pattern shadow detection value of the first candidate shadow area falls in the local-ternary-pattern shadow threshold, wherein, it only requires to substitute the first threshold with the local-ternary-pattern shadow threshold in step S50.

Further, the hue and saturation detection method is as follows:

$$HSV Shadow = \{ 1 , if \begin{matrix}\frac{{\sum }_{i = 1}^{n} \vert {C}_{i}^{h} - {B}_{i}^{h} \vert}{n} \\ 0 , otherwise\end{matrix} < {τ}_{h} \frac{{\sum }_{i = 1}^{n} \vert {C}_{i}^{s} - {B}_{i}^{s} \vert}{n} < {τ}_{s}$$

wherein, Cᵢ^{h} is the hue value of pixels in the current frame, Bᵢ^{h} is the hue value of pixels in the background frame, Cᵢ^{s} is the saturation value of pixels in the current frame, Bᵢ^{s} is the saturation value of pixels in the background, τₕ is the hue threshold, and τₛ is the saturation threshold;

the hue detection value and the saturation detection value in the first candidate shadow areas has an output value of 1 in the range of the hue threshold and the saturation threshold, when a hue average value in the first candidate shadow areas is smaller than the hue threshold and a saturation average value is smaller than the saturation threshold; otherwise, the output value is 0, when the hue detection value and the saturation detection value in the first candidate shadow areas exceeds the range of the hue threshold and the saturation threshold. The hue average value of the first candidate shadow area is an average value of the difference in the hue value between all pixels in the first candidate shadow area and all corresponding pixels in the background frame; similarly, the saturation average value of the first candidate shadow area is an average value of the difference in the saturation value between all pixels in the first candidate shadow area and all corresponding pixels in the background frame. The hue and saturation detection value of a first candidate shadow area can be determined to be in the range of the hue and the saturation threshold or not according to whether the output value is 1 or 0. It should be noted that, compared with the computation and analysis on the H, S, and V channels of the current frame and background frame using the traditional hue, saturation and value (HSV) detectors, the hue and saturation detection proposed by the present application removes the computation of the V channel, mainly uses the chrominance invariance jointly expressed by the H and S channels, and makes full use of the neighborhood information of the H and S channels (such as the adjacent pixel). The hue value threshold and saturation threshold are computed according to the second candidate shadow area, so it will vary with the scene. For a single isolated pixel, the use of neighborhood information can reduce the interference caused by sudden light changes, reduce missed detection, and improve accuracy of the detection.

Further, the gradient detection method is as follows:

$$∇ = \sqrt{{∇}_{x}^{2} + {∇}_{y}^{2}} , θ = arctan ( \frac{{∇}_{y}}{{∇}_{x}} )$$

$$Gradient Shadow = \{ \begin{matrix}1 , if \frac{{\sum }_{i = 1}^{n} {\sum }_{j ϵ \{ b , g , r \}} \vert C ( {∇}_{i}^{j} ) - B ( {∇}_{i}^{j} ) \vert}{n} < {ϕ}_{m} \\ \frac{{\sum }_{i = 1}^{n} {\sum }_{j ϵ \{ b , g , r \}} \vert C ( {θ}_{i}^{j} ) - B ( {θ}_{i}^{j} ) \vert}{n} < {ϕ}_{d} \\ 0 , otherwise\end{matrix}$$

wherein, ∇ₓ is horizontal gradient of the pixel, ∇_{y} is vertical gradient of the pixel, ∇ is the gradient of the pixel, θ is the value of an angle, c(∇₁^{j}) is the gradient of a pixel in the current frame in a color channel B(Δ₁^{j}) is the gradient of a corresponding pixel in the background frame in the same color, φₘ is the gradient threshold. c(θᵢ^{j}) is the value of an angle of a pixel in the current frame in a color channel, B(θᵢ^{j}) is the value of an angle of a corresponding pixel in the background frame in the same color, and φ_{d} is the angle threshold;

the gradient detection value in the first candidate shadow area has an output value of 1 within the gradient threshold range, when an average value of differences in all gradient between all pixels in the current frame and corresponding pixels in the background frame in the red, green and blue channels is smaller than the gradient threshold, and an average value of differences in all angles between all pixels in the current frame and corresponding pixels in the background frame in the red, green and blue channels is smaller than the angle threshold; otherwise, the output value is 0 when the gradient detection value in the first candidate shadow area exceeds the gradient threshold. The gradient detection value of a first candidate shadow area can be determined to be in the range of the gradient threshold or not according to whether the output value is 1 or 0.

Further, the present application further provides a shadow removal method for monitoring video images, which at least comprises the shadow detection method for monitoring video images as shown in the above FIG. 1 to FIG. 5. Specifically, after selecting the shadow area, the shadow removal method further comprises the following steps:

acquiring a foreground frame from the source data; and

removing the shadow area from the current frame via median filtering and void filling in combination with the foreground frame.

By use of the above shadow detection method for monitoring video images as shown in FIG. 1 to FIG. 5, the above shadow removal method for monitoring video images detects very accurate shadow areas, can realize separation of the shadow area and the monitored target after adding post-processing algorithms such as median filtering and void filling, obtains monitored targets with relatively complete and accurate shape and outline after removal of the interference by shadow areas, thereby providing accurate and valid data for pattern recognition algorithms such as further recognition and classification.

Further, the present application further provides a shadow detection system for monitoring video images, for realizing the above shadow detection method for monitoring video images. The shadow detection system for monitoring video images mainly comprises: an extraction module, a first candidate shadow area acquisition module, a second candidate shadow area acquisition module, a first computation module, a threshold estimation module, a second computation module and a shadow area selection module.

The extraction module is used for acquiring a current frame, a background frame or a foreground frame from source data.

The first candidate shadow area acquisition module is used for acquiring, from the current frame, first candidate shadow areas with brightness smaller than that of corresponding areas of the background frame.

The second candidate shadow area acquisition module is used for computing a local-ternary-pattern shadow detection value of all the first candidate shadow areas, and selecting first candidate shadow areas with the local-ternary-pattern shadow detection value greater than a first threshold as second candidate shadow areas.

The first computation module is used for computing a hue detection value, a saturation detection value and a gradient detection value of each of the second candidate shadow areas.

The threshold estimation module is used for estimating a corresponding local-ternary-pattern shadow threshold, a corresponding hue threshold, a corresponding saturation threshold and a corresponding gradient threshold according to the local-ternary-pattern shadow detection value, the hue detection value, the saturation detection value and the gradient detection value of the second candidate shadow areas computed.

The second computation module is used for computing a local-ternary-pattern shadow detection value, a hue detection value, a saturation detection value and a gradient detection value of each of the first candidate shadow areas.

The shadow area selection module is used for selecting first candidate shadow areas whose local-ternary-pattern shadow detection value, hue detection value, saturation detection value and gradient detection value all fall in a range of the local-ternary-pattern shadow threshold, the hue threshold, the saturation threshold and the gradient threshold as shadow areas.

In summary, in the shadow detection method for monitoring video images, the shadow detection system for monitoring video images and the shadow removal method for monitoring video images using the same shadow detection method provided in embodiments of the present application, first candidate shadow areas (rough candidate shadow areas) are first acquired, and a small part of the true second candidate shadow areas are extracted from the first candidate shadow areas for estimating threshold parameters of subsequent three shadow detectors. Based on the principle of texture consistency and chrominance constancy between the shadow area and the corresponding background area, the three shadow detectors are used to extract more accurate shadow areas from the first candidate shadow area in concurrence, and then the all more accurate shadow areas are jointly screened to obtain a more accurate shadow area. Therefore, the shadow detection method for monitoring video images of the present application has significant detection effect when detecting the shadow areas of an acquired monitored target in motion for most common indoor scenes, and can detect very accurate shadow areas. In addition, the algorithm can be applied as an independent module in a monitoring scene, combined with a background modelling or background difference algorithm, and based on the real-time video frame (the current frame), the foreground frame, and the background frame, the algorithm can be implemented and applied to reduce the impact of shadows on the integrity of a target to the maximum extent, so that after the shadow area is removed, the acquired monitored target is also more accurate and complete, which is more in favour of the monitoring of the monitored target.

Although the present application has been disclosed as above with optional embodiments, it is not intended to limit the present application. Those skilled in the technical field to which the present application belongs, without departing from the spirit and scope of the present application, can make various changes and modifications. Therefore, the scope of protection of the present application shall be subject to the scope defined in the claim.

What is claimed is:

1. A shadow detection method for monitoring video images, comprising the following steps:
S10: acquiring a current frame and a background frame from source data;
S20: acquiring, from the current frame, first candidate shadow areas with brightness smaller than that of corresponding areas of the background frame;
S30: computing local-ternary-pattern shadow detection values of all of the first candidate shadow areas, and selecting first candidate shadow areas with the local-ternary-pattern shadow detection values greater than the first threshold as second candidate shadow areas;
S40: computing a hue detection value, a saturation detection value and a gradient detection value of each of the second candidate shadow areas;
S50: estimating a corresponding local-ternary-pattern shadow threshold, a corresponding hue threshold, a corresponding saturation threshold and a corresponding gradient threshold according to the local-ternary-pattern shadow detection value, the hue detection value, the saturation detection value and the gradient detection value of the second candidate shadow areas computed;
S60: computing a local-ternary-pattern shadow detection value, a hue detection value, a saturation detection value and a gradient detection value of each of the first candidate shadow areas; and
S70: selecting first candidate shadow areas whose local-ternary-pattern shadow detection value, hue detection value, saturation detection value and gradient detection value all fall in a range of the local-ternary-pattern shadow threshold, the hue threshold, the saturation threshold and the gradient threshold as shadow areas.

2. The shadow detection method for monitoring video images of claim 1, wherein, the step S10 further comprises acquiring a foreground frame from the source data; and the step S20 comprises the following steps:
S201: computing brightness of each area in the current frame and the background frame, and selecting an area in the current frame with the brightness smaller than that of a corresponding area in the background frame as a first area;
S202: computing three first ratios of spectral frequency respectively in red, green and blue channels of the first area to that of a second area corresponding to the first area in the background frame, as well as three second ratios of spectral frequency respectively in red, green and blue channels of a third area corresponding to the first area in the foreground frame to that of the second area; and
S203: selecting a first area with a difference between the first ratio and the second ratio smaller than a second threshold as the first candidate shadow area.

3. The shadow detection method for monitoring video images of claim 2, wherein, in the step S202, the three first ratios are computed by the following equations:
$${Ψ}_{r} = \frac{{C}_{b} \text{/} {C}_{g}}{{B}_{b} \text{/} {B}_{g}} , {Ψ}_{g} = \frac{{C}_{b} \text{/} {C}_{r}}{{B}_{b} \text{/} {B}_{r}} , {Ψ}_{b} = \frac{{C}_{g} \text{/} {C}_{r}}{{B}_{g} \text{/} {B}_{r}}$$
wherein, Ψᵣ is a first ratio of the spectral frequency in a red channel, Ψ_{g} is a first ratio of the spectral frequency in a green channel, and Ψ_{b} is a first ratio of the spectral frequency in the blue channel; Cᵣ is a spectral frequency of the red channel in the current frame, C_{g} is a spectral frequency of the green channel in the current frame, and C_{b} is a spectral frequency of the blue channel in the current frame; Bᵣ is a spectral frequency of the background frame in the red channel, B_{g} is a spectral frequency of the background frame in the green channel, and B_{b} is a spectral frequency of the background frame in the blue channel.

4. The shadow detection method for monitoring video images of claim 1, wherein, the computation of the local-ternary-pattern shadow detection value comprises the following steps:
computing a local-ternary-pattern computation value of all pixels of the first candidate shadow areas or the second candidate shadow areas in the current frame;
computing a local-ternary-pattern computation value of each corresponding pixel with the same position in the background frame; and
computing the number of the pixels in the first candidate shadow areas or the second candidate shadow areas in the current frame that have the same local-ternary-pattern computation value as the corresponding pixels in the background frame, and
taking the number of the pixels as the local-ternary-pattern shadow detection value.

5. The shadow detection method for monitoring video images of claim 4, wherein, the computation of the local-ternary-pattern computation value at least comprises the following steps:
setting a noise tolerance value;
comparing gray level of each adjacent pixel surrounding the pixel with that of the pixel;
if the difference in the gray level between one of the adjacent pixels and the pixel is smaller than the noise tolerance value, tagging a value of the adjacent pixel as a first value;
if the gray level of one of the adjacent pixels is greater than or equal to the sum of the gray level of the pixel and the noise tolerance value, tagging a value of the adjacent pixel as a second value;
if the gray level of one of the adjacent pixels is smaller than or equal to the difference between the gray level of the pixel and the noise tolerance value, tagging a value of the adjacent pixel as a third value;
grouping the tagged values of all of the adjacent pixels into a first array in a first order;
comparing the gray level of each of the adjacent pixels with another one of the adjacent pixels furthest from the adjacent pixel;
if difference in the gray level between the two adjacent pixels is smaller than the noise tolerance value, then the value formed is the first value;
if the gray level of the adjacent pixel of one of the adjacent pixels is greater than or equal to a sum of the gray level of another one of the adjacent pixel furthest from the adjacent pixel and the noise tolerance value, then the value formed is the second value;
if the gray level of one of the adjacent pixels is smaller than or equal to the difference between the gray level of another one of the adjacent pixels furthest from the adjacent pixel and the noise tolerance value, then the value formed is the third value;
grouping all of the values formed into a second array in a second order; and
adding up the first array and the second array to obtain the local-ternary-pattern computation value.

6. The shadow detection method for monitoring video images of claim 5, wherein, the pixels and a plurality of the adjacent pixels are arranged in a nine-palace lattice, and each of the pixel is surrounded by eight of the adjacent pixels arranged around it.

7. The shadow detection method for monitoring video images of claim 1, wherein, the hue and the saturation are detected by the following equation:
$$HSV Shadow = \{ 1 , if \begin{matrix}\frac{{\sum }_{i = 1}^{n} \vert {C}_{i}^{h} - {B}_{i}^{h} \vert}{n} \\ 0 , otherwise\end{matrix} < {τ}_{h} \frac{{\sum }_{i = 1}^{n} \vert {C}_{i}^{s} - {B}_{i}^{s} \vert}{n} < {τ}_{s}$$
wherein, Cᵢ^{h} is the hue value of pixels in the current frame, Bᵢ^{h} is the hue value of pixels in the background frame, Cᵢ^{s} is the saturation value of pixels in the current frame, Bᵢ^{s} is the saturation value of pixels in the background, m is the hue threshold, and τₛ is the saturation threshold; and
the hue detection value and the saturation detection value in the first candidate shadow area has an output value of 1 in the range of the hue threshold and the saturation threshold, when a hue average value in the first candidate shadow area is smaller than the hue threshold and a saturation average value is smaller than the saturation threshold;
otherwise, the output value is 0, when the hue detection value and the saturation detection value in the first candidate shadow area exceeds the range of the hue threshold and the saturation threshold.

8. The shadow detection method for monitoring video images of claim 1, wherein, the gradient is detected by the following equation:
$$∇ = \sqrt{{∇}_{x}^{2} + {∇}_{y}^{2}} , θ = arctan ( \frac{{∇}_{y}}{{∇}_{x}} )$$
$$Gradient Shadow = \{ \begin{matrix}1 , if \frac{{\sum }_{i = 1}^{n} {\sum }_{j ϵ \{ b , g , r \}} \vert C ( {∇}_{i}^{j} ) - B ( {∇}_{i}^{j} ) \vert}{n} < {ϕ}_{m} \\ \frac{{\sum }_{i = 1}^{n} {\sum }_{j ϵ \{ b , g , r \}} \vert C ( {θ}_{i}^{j} ) - B ( {θ}_{i}^{j} ) \vert}{n} < {ϕ}_{d} \\ 0 , otherwise\end{matrix}$$
wherein, ∇ₓ is horizontal gradient of the pixel, ∇_{y} is vertical gradient of the pixel, ∇ is the gradient of the pixel, θ is the value of an angle, c(∇ᵢ^{j}) is the gradient of a pixel in the current frame in a color channel, s(∇ᵢ^{j}) is the gradient of a corresponding pixel in the background frame in the same color channel, φₘ is the gradient threshold. c(θᵢ^{j}) is the value of an angle of a pixel in the current frame in a color channel, B(θᵢ^{j}) is the value of an angle of a corresponding pixel in the background frame in the same color channel, and φ_{d} is the angle threshold;
the gradient detection value in the first candidate shadow area has an output value of 1 within the gradient threshold range, when an average value of differences in all gradient between all pixels in the current frame and corresponding pixels in the background frame in the red, green and blue channels is smaller than the gradient threshold, and an average value of differences in all angles between all pixels in the current frame and corresponding pixels in the background frame in the red, green and blue channels is smaller than the angle threshold; otherwise, the output value is 0 when the gradient detection value in the first candidate shadow area exceeds the gradient threshold range.

9. A shadow removal method for monitoring video images, comprising at least the following steps for realizing the shadow detection method for monitoring video images:
S10: acquiring a current frame and a background frame from source data;
S20: acquiring, from the current frame, first candidate shadow areas with brightness smaller than that of corresponding areas of the background frame;
S30: computing a local-ternary-pattern shadow detection value of all of the first candidate shadow areas, and selecting first candidate shadow areas with the local-ternary-pattern shadow detection value greater than a first threshold as second candidate shadow areas;
S40: computing a hue detection value, a saturation detection value and a gradient detection value of each of the second candidate shadow areas;
S50: estimating a corresponding local-ternary-pattern shadow threshold, a corresponding hue threshold, a corresponding saturation threshold and a corresponding gradient threshold according to the local-ternary-pattern shadow detection value, the hue detection value, the saturation detection value and the gradient detection value of the second candidate shadow areas computed;
S60: computing a local-ternary-pattern shadow detection value, a hue detection value, a saturation detection value and a gradient detection value of each of the first candidate shadow areas;
S70: selecting first candidate shadow areas whose local-ternary-pattern shadow detection value, hue detection value, saturation detection value and gradient detection value all fall in a range of the local-ternary-pattern shadow threshold, the hue threshold, the saturation threshold and gradient threshold as a shadow area.

10. The shadow removal method for monitoring video images of claim 9, further comprising the following steps after selecting the shadow area:
acquiring a foreground frame from the source data; and
removing the shadow area from the current frame via median filtering and void filling in combination with the foreground frame.

11. A shadow detection system for monitoring video images, wherein, the shadow detection system for monitoring video images comprises:
an extraction module, for acquiring a current frame, a background frame or a foreground frame from source data;
a first candidate shadow area acquisition module, for acquiring, from the current frame, first candidate shadow areas with brightness smaller than that of a corresponding area of the background frame;
a second candidate shadow area acquisition module, for computing a local-ternary-pattern shadow detection value of all the first candidate shadow areas, and selecting first candidate shadow areas with the local-ternary-pattern shadow detection value greater than a first threshold as second candidate shadow areas;
a first computation module, for computing a hue detection value, a saturation detection value and a gradient detection value of each of the second candidate shadow areas;
a threshold estimation module, for estimating a corresponding local-ternary-pattern shadow threshold, a corresponding hue threshold, a corresponding saturation threshold and a corresponding gradient threshold according to the local-ternary-pattern shadow detection value, the hue detection value, saturation detection value and gradient detection value of the second candidate shadow area computed;
a second computation module, for computing a local-ternary-pattern shadow detection value, a hue detection value, a saturation detection value and a gradient detection value of each of the first candidate shadow areas; and
a shadow area selection module, for selecting first candidate shadow areas whose local-ternary-pattern shadow detection value, hue detection value, saturation detection value and gradient detection value all fall in a range of the local-ternary-pattern shadow threshold, the hue threshold, the saturation threshold and the gradient threshold as shadow areas.
